(19) United States
(12) Patent Application Publication
(10) Pub. No.: US 2025/0146709 A1
(43) Pub. Date: May 8, 2025

(54) PREFABRICATED CROSS-LAMINATED TIMBER BUILDING UNIT

(71) Applicant: FlexiHabitat Living, Inc., Walnut, CA (US)

(72) Inventor: An Ni, Walnut, CA (US)

(21) Appl. No.: 18/501,510

(22) Filed: Nov. 3, 2023

(51) Int. Cl. F24S 20/66; E04B 1/10; H02S 20/23; H02S 40/44

(52) U.S. Cl. CPC F24S 20/66; E04B 1/10; H02S 20/23; H02S 40/44

(57) ABSTRACT

Prefabricated building units have been in existence for some time and are gaining popularity. However, existing prefabricated building units have exposed and/or disorganized water pipelines, electricity pipelines and/or other pipelines. They also lack outdoor independent energy supply and, thus, are not suitable in locations with no access to power grid.

### FIELD

This disclosure generally relates to prefabricated building units and a method of constructing these units, and more particularly, to smart prefabricated building units made of Cross-Laminated Timber (CLT).

### BACKGROUND

Prefabricated building units have been in existence for some time and are gaining popularity. However, existing prefabricated building units have exposed and/or disorganized water pipelines, electricity pipelines and/or other pipelines. They also lack an independent energy supply and, thus, are not suitable in locations with no access to the power grid.

### SUMMARY

This disclosure is directed to smart prefabricated building units made of CLT. Some embodiments are directed to the building units and their structures. Other embodiments are directed to methods of constructing these building units.

According to embodiments of the disclosure, a prefabricated CLT building unit is a basic building unit with CLT as the main building member, combined with photovoltaic, photothermal, temperature regulating wall, and an intelligent phase-changing energy storage control system in the building unit. By combining the building units in different ways, the CLT prefabricated building units can be combined for use in different settings such as high-density cities, outdoor camps and tourist attractions according to the respective usage requirements of these settings. They can be combined to form, for example, linear-shaped, cross-shaped, and stacked arrangements to meet these usage requirements. This not only enables fast factory prefabrication and on-site hoisting processes, but also allows the integration of timber structures into steel and concrete structures in cities.

In one embodiment, through the use of intelligent flexible processing production lines in a factory, water pipelines, electricity pipelines, and other pipelines can be precisely positioned in the CLT wallboards. For example, all the pipelines can be pre-buried in different layers of the CLT wallboards. The pipelines are built in and would not affect each other. As such, the wallboards have no exposed pipelines when encapsulated by a veneer.

In one embodiment, through interaction of solar energy, a high-efficient heat pump, a temperature regulating wall, and a fresh air system, solar energy can be used as the main energy source to solve the problem of heating and cooling, provide independent energy supply, and eliminate any dependence on the power grid. The smart prefabricated CLT building unit can be widely used in remote locations such as recreational vehicle (RV) campsites, and other outdoor areas under harsh conditions.

In one embodiment, by using prefabricated CLT as the main member of a modular building, an intelligent flexible production line can be used to perform layer-by-layer processing on CLT wallboards to form slots in the layers for various pipelines. This allows all pipelines in the building units to be built in the wallboards. Slots can be formed in layers in a CLT wallboard according to the different types and sizes of the pipelines. Problems such as pipeline exposure and disorganized crossing of pipelines in existing prefabricated building units can therefore be avoided.

In one embodiment, the smart prefabricated CLT building unit can be equipped with an energy system to provide power supply, cooling and heating of modular buildings constructed from one or more of these CLT building units. In one example, the energy system can include a solar energy module, a high-efficient heat pump, a temperature regulating wall, and a fresh air system. Solar energy can be used as the main energy source and fossil energy as an auxiliary energy source to supply hot water and/or provide cooling/heating around the clock, thereby eliminating geographic, climatic, and other limitations that often make existing prefabricated building modules less ideal for certain locations. A photovoltaic power generation and energy storage system can provide electric energy for a building constructed from the disclosed prefabricated CLT building units.

In one embodiment, a smart prefabricated CLT building unit can include a CLT building body, the interior of which can include one or more CLT constructed building blocks, an embedded capillary network being positioned in the interior of the wallboards of the CLT building body, and a solar photovoltaic collecting mechanism being positioned on the top of the CLT building body. Each building block made of CLT can be composed of an orthogonal assembly of at least three layers of solid sawn wood or structural composite panels. Each CLT constructed building block can be pressed by a structural adhesive to form a rectangular, linear, or planar board. The CLT building body can be formed by an arbitrary combination of the CLT constructed building blocks according to the intended usage and/or location of the CLT building unit.

In one embodiment when the CLT building body is applied to recreational vehicle campsites, vacation scenic spots, or areas without municipal power supply, the CLT building body can be assembled as a cuboid from the CLT constructed building blocks. Multiple cuboid units can be combined to form linear-shaped, cross-shaped, or other-shaped combined spaces. When the CLT constructed building blocks are combined, connecting parts can be removed to form a run-through space.

In one embodiment, when being applied in urban space, the CLT building body can be used through the combination of the CLT constructed building blocks in concrete and steel structure buildings in a large space. The CLT constructed building blocks can be formed into different forms of combinations by having them stacked up, connected side by side or front to back. That is, the CLT building body can form an independent timber structure building space in a large concrete or steel structure space.

In one embodiment, one or more CLT constructed building blocks can be assembled to construct a CLT building body. A CLT building body can be formed based on different functional requirements and application scenarios through different combinations of the CLT constructed building blocks. The walls of the CLT building body can be embedded with a capillary network connected to a solar photovoltaic heat collecting mechanism to provide heating.

In one embodiment, the CTL building body can additionally include an active energy conservation system. The active energy conservation system can be equipped with a chromium telluride photovoltaic system and a solar hot water heat collecting system. A capillary network heating system can be disposed at the center of the active energy conservation system. The chromium telluride photovoltaic system, the solar hot water collecting system, and the capillary network heating system can be integrated with the active energy conservation system.

In one embodiment, bi-directional electrical transmission can exist between the active energy conservation system and each of the chromium telluride photovoltaic system, the solar hot water collecting system, and the capillary network heating system.

In one embodiment, the active energy conservation system can be connected to a solar flat plate water heater. A water heater connecting pipe connects the active energy conservation system and the solar flat plate water heater. A temperature regulating wall is disposed at a location where the active energy conservation system is connected to the water heater connecting pipe. The water heater connecting pipe can be provided with a first heat exchange water tank, a second heat exchange water tank, and a pressure tank. The water heater connecting pipe can be connected to an air source heat pump. The active energy conservation system can be connected to a chromium telluride photovoltaic module. A photovoltaic module connector can connect the active energy conservation system and the chromium telluride photovoltaic module. A distribution box can be positioned at a location where the active energy conservation system is connected to the photovoltaic module connector. The photovoltaic module connector can be provided with a storage energy inverter and an energy storage battery. The photovoltaic module connector can be connected to the air source heat pump.

In one embodiment, the chromium telluride photovoltaic module can be connected to the active energy conservation system through the photovoltaic module connector. The photovoltaic module connector can be electrically connected to the power distribution box. The photovoltaic module connector can be electrically connected to the energy storage battery and the energy storage inverter. The solar flat plate water heater can be connected to the active energy conservation system through the water heater connecting pipe. The body temperature wall can be electrically connected to the water heater connecting pipe. The water heater connecting pipe can be electrically connected to the pressure tank, the first heat exchange water tank, and the second heat exchange water tank.

In one embodiment, a veneer can be positioned on the outer surface of the CLT building body. A cold water pipe slot, a hot water pipe slot, a wire pipe slot, a capillary main return pipe slot, and a capillary main inlet pipe slot can be positioned in the interior of the wallboards of the CLT building body. A capillary branch pipe slot can be formed in a location where the embedded capillary network is positioned in the wallboards of the CLT building body.

In one embodiment, the interior of the wallboards of the CLT building body can be integrally molded with the cold water pipe slot, the hot water pipe slot, the wire pipe slot, the capillary main return pipe slot, the capillary main inlet pipe slot, and the capillary branch pipe slot. Placement of the various pipes can be facilitated by the cold water pipe slot, the hot water pipe slot, the wire pipe slot, the capillary main return pipe slot, the capillary main inlet pipe slot, and the capillary branch pipe slot in the wallboards of the CLT building body. All pipelines can be pre-buried in different layers in the members of the wallboards of the CLT building body. A sealed encapsulation can be formed between the CLT building body and the veneer.

Compared with the prior art, the embodiments of the smart prefabricated CLT building unit can have the following beneficial effects. First, an intelligent flexible production line is used to perform layer-by-layer processing on wallboards of the CLT building unit to form slots for pre-buried pipelines. This eliminates the problem of exposed pipelines in existing CLT building units. In the embodiments, all pipelines are built in, and slots are formed in layers in a CLT wallboard according to the different types and sizes of the pipelines. Problems such as pipeline exposure and disorganized crossing of the pipelines are avoided when various building units are combined.

To enable anti-freezing in winter in cold areas and anti-overheating in summer in hot areas, a pressurized independent circulating system can be employed in the embodiments. The pressurized independent circulating system can exchange heat with a water system through pipes of a water tank by using a liquid coolant as the medium. A circulating pump can operate automatically according to the set control strategy. This system, in combination with an air source, can effectively solve overheating and/or freezing by having solar energy, a high-efficient heat pump, a temperature regulating wall, and a fresh air system working in tandem, using solar energy as the main energy source and fossil energy the auxiliary energy source to supply hot water and provide cooling/heating around the clock. This eliminates geographic, climatic, and other limitations of existing prefabricated buildings. This system effectively integrates the electrical, heating, cooling, and water systems, thereby reducing costs and carbon emission of the CLT building unit.

Because relatively small wood can be used in the manufacturing process of CLT, high resource utilization efficiency can be achieved through cross stacking of these relatively small wood, according to some of the embodiments.

Because wood has the capability of capturing carbon dioxide, and the glue used in the process of manufacturing CLT can be an environment-friendly glue with no harmful substance, CLT has lower carbon emission than traditional building materials, thus helping to reduce greenhouse gas emission.

The energy consumed during manufacturing of CLT is relatively low. Compared to other building materials such as steel or concrete, CLT consumes less energy in the production process.

The wood used by CLT can be sourced from sustainable forestry management, ensuring reproducibility of the wood.

CLT also has higher durability and strength and can be used in various building and structural applications. At the end of its service life, CLT can be recycled, reducing the generation of building waste.

In a CLT building unit, the wall, floor, roof, and other stress-bearing parts are all composed of CLT, which can unify the modulus of the building unit, and can effectively reduce the types of building parts, facilitate large-scale smart manufacturing in factories, and reduce cost. Embodiments of the smart prefabricated CLT building unit have simple structures, are easy to operate, and have better usability than existing prefabricated building units.

### BRIEF DESCRIPTION OF THE DRAWINGS

FIG. 1 is a diagram illustrating an exemplary smart prefabricated CLT building unit, according to an embodiment of the present disclosure.

FIG. 2 is a structure diagram of an exemplary CLT constructed building block in the smart prefabricated CLT building unit, according to an embodiment of the present disclosure.

FIG. 3 is diagram illustrating the exemplary modules of an active energy maintenance system of a smart prefabricated CLT building unit, according to an embodiment of the disclosure.

FIG. 4 is a structure diagram showing exemplary connections of the active energy maintenance system in a smart prefabricated CLT building unit, according to an embodiment of the present disclosure.

FIG. 5 is a diagram showing an exemplary positioning of the pipelines in a smart prefabricated CLT building unit, according to an embodiment of the disclosure.

FIG. 6 is a diagram showing an exemplary structure of a solar flat plate water heater in a smart prefabricated CLT building unit, according to an embodiment of the present disclosure.

FIG. 7 is a diagram of an exemplary chromium telluride photovoltaic module in the smart prefabricated CLT building unit, according to an embodiment of the present disclosure.

FIG. 8 illustrates a flat plate heat collecting system that includes a flat plate heat collector, according to an embodiment of the disclosure.

### DETAILED DESCRIPTION

Embodiments of the present disclosure will be described below in conjunction with the accompanying drawings, but it should be appreciated by those skilled in the art that the embodiments described below are exemplary, rather than exhaustive. They are only used to illustrate the present disclosure and should not be regarded as limiting the scope of the present disclosure. All other embodiments obtained by those of ordinary skill in the art without creative efforts based on the embodiments disclosed herein shall fall within the scope of the present disclosure.

In the description of the present invention, it should be noted that the directional or positional relationships indicated by terms “central”, “up”, “down”, “left”, “right”, “vertical”, “horizontal”, “inner”, “lower”, etc. are directional or positional relationships shown in the drawings, which are merely for the purpose of describing the exemplary embodiments, rather than indicating or implying that the referred devices or elements must have specific directions or be constructed and operated in specific directions, and, thus cannot be construed as limitations to the disclosed embodiments. Moreover, the terms “first”, “second,” “third,” etc. are not intended to indicate or imply relative importance.

In the description of the embodiments, it should be noted that unless otherwise expressly stipulated and defined, the term “connection” should be understood to be referring to any type of connections including but not limited to a fixed connection, a detachable connection, and an integral connection, that can be a mechanical connection or an electrical connection, a direct connection or an indirect connection through an intermediate, or an internal communication of two elements.

In the figures:
1, CLT building body;
2, active energy conservation system;
3, chromium telluride photovoltaic system;
4, solar hot water heat collecting system;
5, veneer;
6, capillary network heating system;
7, cold water pipe trough;
8, distribution box;
9, temperature regulating wall;
10, hot water pipe slot;
11, wire pipe slot;
12, capillary branch pipe slot;
13, first heat exchange water tank;
14, capillary main return pipe slot;
15, pressure tank;
16, capillary main inlet pipe slot;
17, solar flat plate water heater;
18, air source heat pump;
19, chromium telluride photovoltaic module;
20, energy storage battery;
21, energy storage inverter;
22, second heat exchange water tank;
23, water heater connecting pipe;
24, photovoltaic module connector;
25, CLT constructed building block;
26, embedded capillary network;
27, solar photovoltaic collecting mechanism.

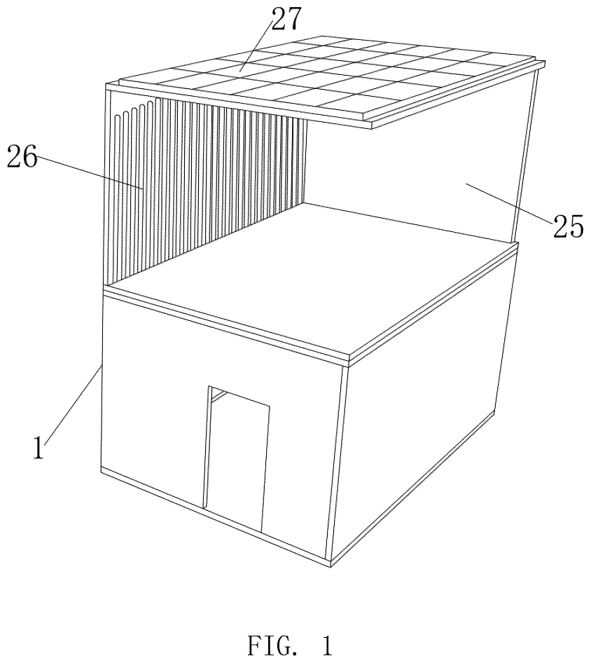

FIGS. 1 to 7 illustrate embodiments of a smart prefabricated CLT building unit including a CLT building body. FIG. 1 illustrates an embodiment of a CLT building body 1, the interior of which includes one or more CLT constructed building blocks 25, an embedded capillary network 26 being positioned in the interior of the wallboards of the CLT building body 1, and a solar photovoltaic collecting mechanism 27 located on the top of the CLT building body 1.

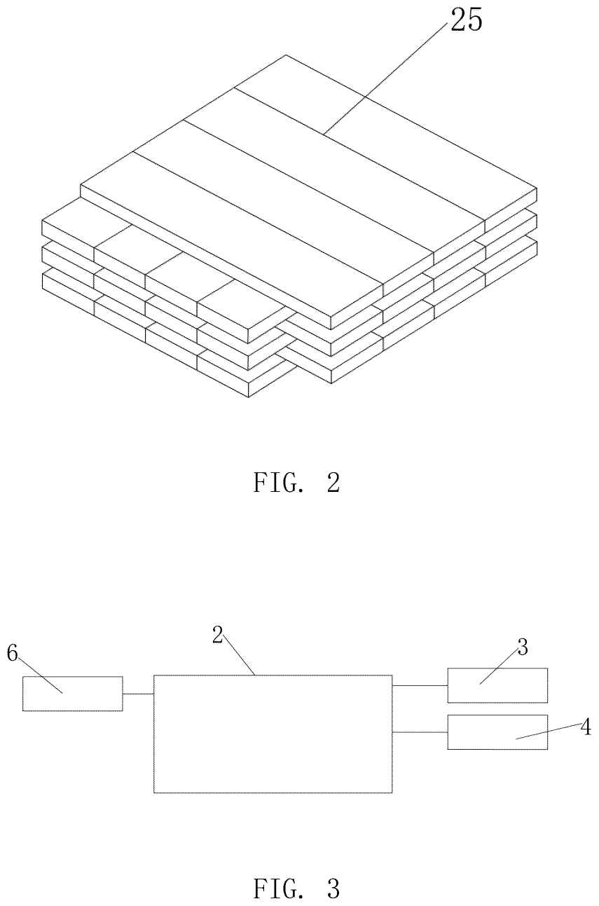

As illustrated in FIG. 2, each CLT constructed building block 25 can be orthogonally assembled by at least one of three-layer solid wood sawn timber and structural composite panels. The CLT constructed building block 25 can be pressed by a structural adhesive to form a rectangular, linear, or planar board. The CLT building body 1 can be formed by arbitrary combination of the CLT constructed building blocks 25 according to different applications and/or requirements.

Referring back to FIG. 1, the capillary network 26, and all the water and electricity pipelines can be placed in slots in the CLT wallboards. Layer-by-layer processing on the CLT wallboards can be performed using a smart flexible production line to form the slots for the capillary network 26 and pipelines. Slots for the pipelines can be formed in the layers in a CLT wallboard according to the different types and sizes of the pipelines. This avoids problems such as exposed pipelines and disorganized crossing of the pipelines, especially when various forms of the building units are combined. This also provides an anti-freezing solution in winter in cold areas and an anti-overheating solution in summer in hot areas. Furthermore, having the pipelines pre-buried in the wallboards enables the solar panels, high-efficient heat pump, temperature regulating wall, and fresh air system to work co-operatively to provide cooling and heating around the clock for the CLT building body 1, as explained below. In one embodiment, solar energy can be used as the main energy source and fossil energy can be used as an auxiliary energy source to supply hot water, cooling, and heating, thereby eliminating geographic, climatic, and other limitations that are often associated with existing prefabricated buildings.

Further, when the CLT building body 1 is applied to, for example, recreational vehicle campsites, vacation scenic spots, and areas without municipal power supply, the CLT building body 1 can be assembled as a cuboid from one or more CLT constructed building blocks 25. Multiple cuboid units can be combined to form linear-shaped, cross-shaped, or other shaped combined spaces. When multiple CLT constructed building blocks 25 are combined, connecting parts can be removed to form a run-through space.

Further, when being applied in urban space, the CLT building body 1 can be used through the combination of the CLT constructed building block(s) 25 within concrete and steel structure buildings in a large space. The CLT constructed building units 25 can be formed into different forms of combinations by being stacked up, placed side-by-side or front to back. The CLT building body 1 can form an independent timber structure building space within a large concrete or steel structure space.

Further, the CLT constructed building block(s) 25 can be assembled as the CLT building body 1. The CLT building body 1 can be constructed based on different functional requirements and application scenarios through different combinations of the CLT constructed building blocks 25. The wall inserts of the CLT building body 1 can be connected to the embedded capillary network 26 and the solar photovoltaic collecting mechanism 27, enabling heating for the space inside the CLT building body 1. As for the wall inserts of the CLT building body 1, the capillary network 26, the water pipelines and electricity pipelines, a smart flexible production line can be used to perform layer-by-layer processing on CLT wallboards to form slots for the capillary network 26 and pipelines. This allows all the pipelines to be built into the wallboards and eliminates any exposed pipelines. Slots can be formed in layers in a CLT wallboard according to the different types and sizes of the pipelines to be placed in these slots. Problems such as exposed pipelines and disorganized crossing of the pipelines can be avoided when various combinations of the building units are put together.

Referring to FIG. 3, in this embodiment, the smart prefabricated CLT building unit includes an active energy conservation system 2, which is connected to a chromium telluride photovoltaic system 3 and a solar hot water heat collecting system 4. A capillary network heating system 6 can be disposed at the center of the active energy conservation system 2. The chromium telluride photovoltaic system 3, the solar hot water heat collecting system 4, and the capillary network heating system 6 can be integrated with the active energy conservation system 2.

Further, bi-directional electrical transmission can exist between the active energy conservation system 2 and each of the chromium telluride photovoltaic system 3, the solar hot water collecting system 4, and the capillary network heating system 6.

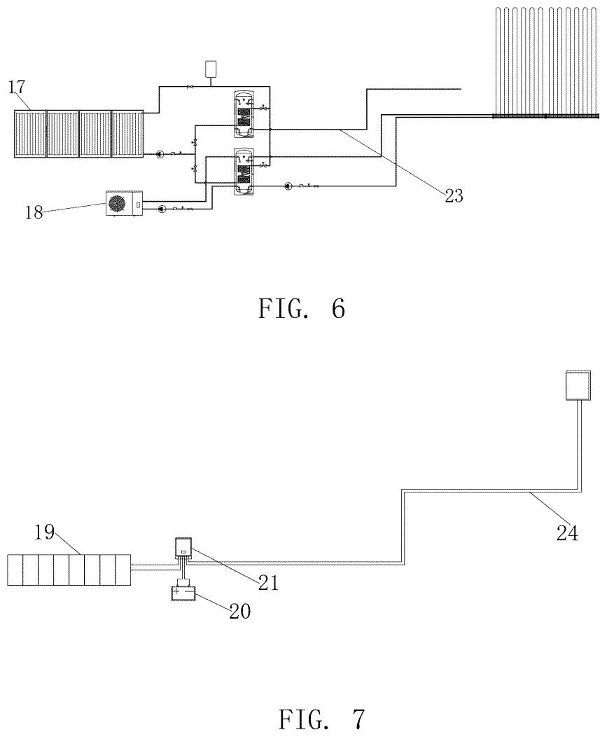

In one embodiment, as illustrated in FIG. 4, the active energy conservation system 2 can be connected to a solar flat plate water heater 17. A water heater connecting pipe 23 connects the active energy conservation system 2 to the solar flat plate water heater 17. A temperature regulating wall 9 can be disposed at a location where the active energy conservation system 2 is connected to the water heater connecting pipe 23. The water heater connecting pipe 23 can be provided with a first heat exchange water tank 13, a second heat exchange water tank 22, and a pressure tank 15. The water heater connecting pipe 23 can be connected to an air source heat pump 18. (See also FIG. 6) The active energy conservation system 2 can be connected to a chromium telluride photovoltaic module 19. As illustrated in FIGS. 4 and 7, a photovoltaic module connector 24 can connect the active energy conservation system 2 to the chromium telluride photovoltaic module 19. A distribution box 8 can be disposed at a location where the active energy conservation system 2 is connected to the photovoltaic module connector 24. The photovoltaic module connector 24 can be provided with a storage energy inverter 21 and an energy storage battery 20. The photovoltaic module connector 24 can be connected to the air source heat pump 18.

As illustrated in FIG. 4, the chromium telluride photovoltaic module 19 can be connected to the active energy maintenance building system 2 through the photovoltaic module connector 24. The photovoltaic module connector 24 can be electrically connected to the power distribution box 8. The photovoltaic module connector 24 can be electrically connected to the energy storage battery 20 and the energy storage inverter 21. The solar flat plate water heater 17 can be connected to the active energy maintenance building system 2 through the water heater connecting pipe 23. (See also FIG. 6) The temperature regulating wall 9 can be electrically connected to the water heater connecting pipe 23. The water heater connecting pipe 23 can be electrically connected to the pressure tank 15, the first heat exchange water tank 13, and the second heat exchange water tank 22.

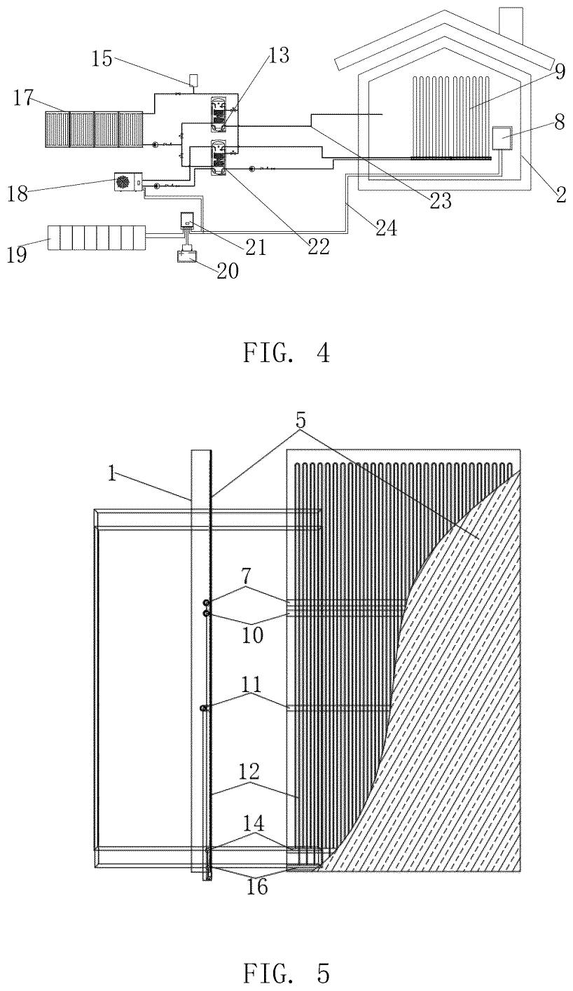

Referring to FIG. 5, a veneer 5 can be positioned on the outer surface of the CLT building body 1. A cold water pipe slot 7, a hot water pipe slot 10, a wire pipe slot 11, a capillary main return pipe slot 14, and a capillary main inlet pipe slot 16 can be positioned in the interior of the wallboards of the CLT building body 1. A capillary branch pipe slot 12 can be formed in a location where the embedded capillary network 26 is positioned in the wallboards of the CLT building body 1.

According to the embodiment illustrated in FIG. 5, the interior of the wallboards of the CLT building body 1 can be integrally molded with the cold water pipe slot 7, the hot water pipe slot 10, the wire pipe slot 11, the capillary main return pipe slot 14, the capillary main inlet pipe slot 16, and the capillary branch pipe slot 12. The placement of the various pipelines can be achieved using the cold water pipe slot 7, the hot water pipe slot 10, the wire pipe slot 11, the capillary main return pipe slot 14, the capillary main inlet pipe slot 16, and the capillary branch pipe slot 12 in the wallboards of the CLT building body 1. All pipelines are pre-buried in different layers of the CLT building body 1. Sealed encapsulation can be formed between the CLT building body 1 and the veneer 5.

CLT is an engineered wood product prefabricated in factories, which is orthogonally assembled using at least three-layer solid wood sawn timber or structural composite panels and can be pressed into the form of rectangular, linear or planar board by using a structural adhesive. It is used for cross-laminated timber wallboards and ceilings of residential and non-residential buildings. By virtue of processing technology, such timber has good strength, can bear large loads, and has excellent thermal insulating performance. The vertical sheet of the board determines the bearing capacity, while the horizontal sheet thereof determines the longitudinal stiffness.

Based on the different intended purposes of the CLT building blocks, the CLT building blocks can be combined arbitrarily.

In a first example, an embodiment of the smart prefabricated CLT building unit is to be built at a recreational vehicle campsite, vacation scenic spot, or any other area without municipal power supply. The characteristics of high strength and light weight of CLT products can be utilized, which facilitates hoisting and combination in these types of areas. Meanwhile, “linear-shaped”, “cross-shaped” and other-shaped combined spaces can be formed by combining multiple cuboid units. The characteristic that CLT walls are easy to remove is utilized so that a plurality of CLT building blocks can be combined into a large run-through space. The applicability of the CLT building blocks can be greatly improved. That is, the CLT building unit can meet not only the residential needs of individuals in small spaces, but also the living, entertainment, and other needs of multi-person teams.

In a second example, an embodiment of the smart prefabricated CLT building unit can have application in an urban space. Buildings in urban cities are dense with high-rise and super-high-rise buildings dominant in the development of buildings. The CLT building blocks can be combined for use within concrete and steel structure buildings in a large space. Different forms of combinations can be formed by stacking up the CLT building blocks, placing them side by side or front and back, so as to form a timber structure building environment within a large space. This allows urban residents to experience timber structure residential environments in cities without being subject to the constraints of the urban space.

Referring to FIGS. 1-5 again, the embodiments illustrated in these figures comprise a CLT building body 1, an active energy conservation system 2, a chromium telluride photovoltaic system 3, a solar hot water collecting system 4, a veneer 5, a capillary network heating system 6, a cold water pipe trough 7, a distribution box 8, a body temperature wall 9, a hot water pipe slot 10, a wire pipe slot 11, a capillary branch pipe slot 12, a first heat exchange water tank 13, a capillary main return pipe slot 14, a pressure tank 15, a capillary main inlet pipe slot 16, a solar flat plate water heater 17, an air source heat pump 18, a chromium telluride photovoltaic module 19, an energy storage battery 20, an energy storage inverter 21, a second heat exchange water tank 22, a water heater connecting pipe 23, a photovoltaic module connector 24, a CLT constructed building unit 25, an embedded capillary network 26, and a solar photovoltaic collecting mechanism 27.

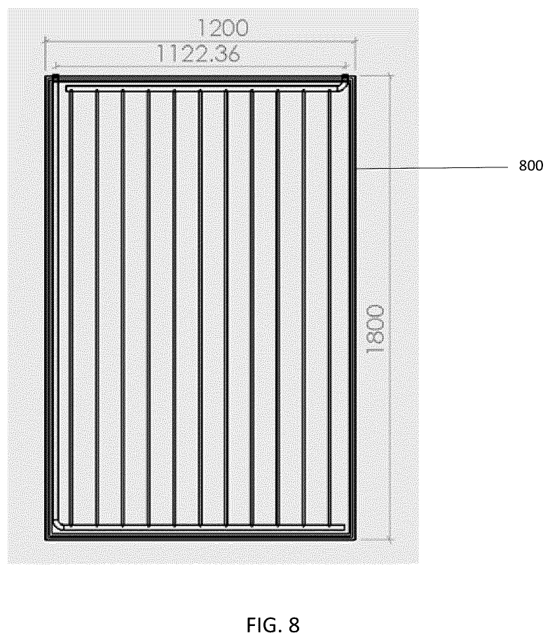

In one embodiment, a flat plate heat collecting system can include a flat plate heat collector (800 in FIG. 8), a water tank with coiled pipes, pipes, valves, a circulating pump, a working medium, etc., where the working medium can be a 67% glycerol aqueous solution, which has a boiling point of 290° C. and a freezing point of −46.5° C. This system can produce hot water from room temperature to 85° C.

The system can provide overheating protection and strategies for setting water temperature. In one embodiment, temperature T1 is a temperature sensed by a temperature sensing probe of the flat plate heat collector, and temperature T2 is a temperature sensed by a probe of the water tank. When T1>the set value of T2, the controller can start the operation of the circulating pump, and the working medium in the flat plate heat collector 800 circulates to transfer heat to the water tank. In the operation process of the circulating pump, when T1<the set value of T2, the circulating pump can be stopped. An air source heat pump system can start. The water temperature of the upper part of the water tank can be automatically maintained to be constant at the set value.

In summer, because cooling is required indoors, the flat plate heat collecting system can automatically switch to the hot water system. The water tank No. 1 can be used for providing hot water. The air source system starts, and the water tank No. 2 can be used for providing a cooling source for the temperature regulating wall system. The photovoltaic energy storage system can provide electric energy for the air source.

During the daytime in winter, the air collector and flat plate heat collecting systems are dominant to provide heat to the interior of a room. The air collector system can provide hot air to the interior of the room, inducing convection in the room. The flat plate heat collecting system can provide a heat source for the temperature regulating wall system, and the heat source can provide radiant heat. When the control system is automatic, hot water provided by the flat plate heat collecting system can have a temperature of 40 to 42° C. When the control system is manual, hot water provided by the flat plate heat collecting system can have a temperature as high as 85° C. The air source system can start when the temperature in the water tank falls below a set value. The photovoltaic energy storage system can provide electric energy for the air source.

At night in winter, the air collector and flat plate heat collecting systems can be stopped. The air source can use the photovoltaic energy storage system to provide a heat source for the temperature regulating wall and provide hot water at the same time. The photovoltaic energy storage system can provide electric energy for the air source.

Below is exemplary analysis and calculation on the cooling and heating capacities supplied by the above-described system. For example, for a room with an indoor area of 100 m², a G20 capillary is used. In summer, the outdoor dry-bulb temperature is 34.4° C.; the indoor air temperature is 29° C.; the water supply temperature of the system is 17° C.; and the integrated cooling capacity of the body temperature wall is 120 w/m². In winter, the outdoor dry-bulb temperature is −3° C.; the indoor air temperature is 15° C.; the water supply temperature is 35° C.; and the integrated heating capacity of the body temperature wall is 190 w/m². According to the standard of timber structure buildings, the cold load is 140 w/m², the heat load is 80 w/m². For a room with an indoor area of 100 m², a 117 m² temperature regulating wall can achieve the design requirements. Three flat plate heat collectors can meet the needs of heating in winter and hot water for 3 people.

In summary, for a room with an indoor area of 100 m², the 117 m² temperature regulating wall is used, and three 1200×1800 mm flat plate heat collecting systems plus the air source can serve as auxiliaries. This can meet the needs of summer cooling, winter heating, and 80 L/person domestic hot water for 3 persons per day.

The difficulties in design of the flat plate heat collector lie in locations of water inlets and outlets and the fact that pipes connected in series are not constraint by, for example, the 2 CM mounting gap. In one embodiment, the water inlets and outlets pass through the roof to enter the interior of the room, and the connection between the inlets and outlets is made in the room, thereby facilitating serial and parallel connections of the flat plate heat collectors.

The flat plate heat collecting system provides a solution to the freezing problem in winter in cold areas and the overheating problem in summer in hot areas. As such, this system can adopt a pressurized independent circulatory system, and exchanges heat with a water system through coiled pipes of the water tank by using a liquid coolant as a medium. The circulating pump can operate automatically according to a set control strategy and can be combined with the air source to effectively solve the overheating and anti-freezing problems.

The flat plate heat collecting system can achieve the cooperative use of solar energy, a high-efficient heat pump, a temperature regulating wall and a fresh air system. Solar energy can be used as the main energy source and fossil energy as an auxiliary energy source to supply hot water and provide cooling/heating around the clock, eliminating geographic, climatic and other limitations that often make existing prefabricated building modules less ideal for certain locations. This further integrates electrical, heating, cooling and water systems, thereby reducing costs and carbon emission.

The CLT building units can be formed based on different functional requirements and application scenarios through different ways of combining the prefabricated CLT building blocks. For example, in some outdoor tourist attractions, two CLT building blocks can horizontally or vertically combined to form linear-shaped, cross-shaped and other-shaped combinations. In this way, multiple building blocks can be utilized to form different usage functions. For example, when the two CLT building blocks are combined, the walls affixed together can be removed, so as to form a run-through space, creating a large multi-functional space. As another example, 3 boxes can be stacked vertically to be placed in a large space in a concrete or steel structure (with a single-story height of 9 meters or more). This not only allows the residents to experience a timber structure residential environments in cities, but also removes constraints of the urban space.

Embodiments of the prefabricated building block utilize photovoltaic, photothermal, and other technologies to obtain a very good indoor comfort level. Through roof or wall photovoltaic, the buildings constructed from embodiments of the prefabricated CLT building blocks can generate electricity by themselves, so as to achieve zero pollution. The CLT building unit may be arranged outdoor in remote areas without municipal power supply.

It should be noted that, relationship terms such as first and second (No. 1, No. 2) herein are only used to distinguish one entity or operation from another one, but do not necessarily require or imply the presence of any such actual relationship or order between these entities or operations.

The basic principles and main features of the present are shown in the figures and described above. Those skilled in the art should understand that the present invention is not limited by the above embodiments, the above embodiments and the description in the specification are only illustrative of the principles of the present invention. Various variations and improvements of the present invention also exist without departing from the spirit and scope of the present invention, and they all fall within the scope of the present disclosure sought for protection.

What is claimed is:

1. A cross-laminated timber (CLT) building body comprising:
one or more CLT constructed building blocks,
a capillary network being embedded in an interior of one or more wallboards of the CLT building body, and
a solar photovoltaic collecting mechanism located on the top of the CLT building body.

2. The CLT building body of claim 1, wherein each CLT constructed building block is orthogonally assembled by at least one of three-layer solid wood sawn timber and structural composite board.

3. The CLT building body of claim 1, wherein the one or more of the wallboards comprises a plurality of slots for the capillary network, water and electricity pipelines.

4. The CLT building body of claim 1, further comprising:
an active energy conservation system;
a chromium telluride photovoltaic system; and
a solar hot water collecting system; and
wherein each of the chromium telluride photovoltaic system, the solar hot water collecting system, and the capillary network is connected to the active energy conservation system via a bi-directional electrical transmission.

5. The CLT building body of claim 4, wherein the active energy conservation system is connected to a solar flat plate water heater via a watch heater connecting pipe.

6. The CLT building body of claim 5, further comprising a temperature regulating wall disposed at a location where the active energy conservation system is connected to the water heater connecting pipe.

7. The CLT building body of claim 6, wherein the water heater connecting pipe 23 is provided with a first heat exchange water tank, a second heat exchange water tank, and a pressure tank.

8. The CLT building body of claim 7, wherein the water heater connecting pipe is connected to an air source heat pump.

9. The CLT building body of claim 8, wherein the active energy conservation system is connected to a chromium telluride photovoltaic module.

10. The CLT building body of claim 4, further comprises a photovoltaic module connector configured to connect the active energy conservation system to the chromium telluride photovoltaic module.

11. The CLT building body of claim 10, further comprises a distribution box configured to be disposed at a location where the active energy conservation system is connected to the photovoltaic module connector.

12. The CLT building body of claim 11, wherein the photovoltaic module connector is provided with a storage energy inverter and an energy storage battery.

13. The CLT building body of claim 12, wherein the photovoltaic module connector is electrically connected to the energy storage battery and the energy storage inverter.

14. The CLT building body of claim 10, wherein the photovoltaic module connector is connected to the air source heat pump.

15. The CLT building body of claim 1, further comprising a veneer positioned on an outer surface of the CLT building body.

16. The CLT building body of claim 1, further comprising a capillary main inlet pipe slot positioned in an interior of a wallboard of the CLT building body.

17. The CLT building body of claim 1, wherein an interior of the CLT building body 1 is integrally molded with a cold water pipe slot, a hot water pipe slot, a wire pipe slot, a capillary main return pipe slot, a capillary main inlet pipe slot, and a capillary branch pipe slot.

18. The CLT building body of claim 5, wherein the flat plate heat collecting system comprises a flat plate heat collector, a water tank with coiled pipes, pipes, valves, a circulating pump, and a working medium.
